(19) United States
(12) Patent Application Publication
(10) Pub. No.: US 2025/0369607 A1
(43) Pub. Date: Dec. 4, 2025

(54) Wearable Safety Lighting System

(71) Applicant: Orion Lighting Technologies, LLC, Sheridan, WY (US)

(72) Inventors: Spencer Evans, Fort Collins, CO (US); Jake Trenholm, Fort Collins, CO (US); Truman Spring, Laie, HI (US); Emma Frost, Fort Collins, CO (US)

(21) Appl. No.: 19/227,358

(22) Filed: Jun. 3, 2025

Related U.S. Application Data
(60) Provisional application No. 63/655,109, filed on Jun. 3, 2024.

(51) Int. Cl. F21V 33/00; A41D 1/00; A41D 1/04; F21Y 115/10

(52) U.S. Cl. CPC F21V 33/0064; A41D 1/002; A41D 1/04; F21Y 2115/10

(57) ABSTRACT

A wearable safety lighting system includes a belt portion extending in a longitudinal direction and having a central longitudinal axis. The belt portion has a cut out portion that also extends in a longitudinal direction, and the cut out portion is centered on the belt portion along the central longitudinal axis. One or more LED light sources is positioned inside the cut out portion of the belt portion.

### CROSS-REFERENCE TO RELATED APPLICATIONS

This application claims the benefit of and priority to U.S. Provisional Patent Application Ser. No. 63/655,109, filed on Jun. 3, 2024, which is incorporated herein by reference in their entirety.

### BACKGROUND

The present invention relates to safety equipment. In the realm of safety equipment, a reflective belt or vest is often used to improve the visibility of a wearer of the reflective belt or vest, but are limited to only that purpose.

Accordingly, there are a number of disadvantages in the field of safety equipment.

### BRIEF SUMMARY

Embodiments of the present disclosure can address one or more problems in the art by providing a wearable safety system. In particular, embodiments of the present disclosure can include a wearable safety lighting system that can include a belt portion extending in a longitudinal direction and having a central longitudinal axis. The belt portion can have a cut out portion that also extends in a longitudinal direction, and the cut out portion can be centered on the belt portion along the central longitudinal axis. One or more LED light sources can be positioned inside the cut out portion of the belt portion.

Additionally or alternatively, embodiments of the present disclosure can include a wearable safety lighting system that can include a belt portion extending in a longitudinal direction and having a central longitudinal axis. The belt portion can have a cut out portion that also extends in a longitudinal direction, and the cut out portion can be centered on the belt portion along the central longitudinal axis. One or more LED light sources can be positioned inside the cut out portion of the belt portion. A computer system can be attached to the belt portion and can be in communication with the one or more LED light sources. The computer system can include one or more processors and one or more computer-readable hardware storage devices that store instructions that can be executable by the one or more processors to cause the computer system to selectively display, on the one or more LED light sources, a lighting regime that can include at least one color.

Additionally or alternatively, embodiments of the present disclosure can include a wearable safety lighting system that can include a belt portion extending in a longitudinal direction and having a central longitudinal axis. The belt portion can have a cut out portion that also extends in a longitudinal direction, and the cut out portion can be centered on the belt portion along the central longitudinal axis. One or more LED light sources can be positioned inside the cut out portion of the belt portion. A computer system can be attached to the belt portion and can be in communication with the one or more LED light sources. The computer system can include one or more processors and one or more computer-readable hardware storage devices that store instructions that can be executable by the one or more processors to cause the computer system to retrieve data from the one or more sensors, determine, based on the data, a corresponding lighting regime, and display, on the one or more LED light sources, the corresponding lighting regime.

Additional features and advantages of exemplary embodiments of the present disclosure will be set forth in the description which follows, and in part will be obvious from the description, or may be learned by the practice of such exemplary embodiments. The features and advantages of such embodiments may be realized and obtained by means of the instruments and combinations particularly pointed out in the appended claims. These and other features will become more fully apparent from the following description and appended claims or may be learned by the practice of such exemplary embodiments as set forth hereinafter.

### BRIEF DESCRIPTION OF THE DRAWINGS

In order to describe the manner in which the above-recited and other advantages and features of the disclosure can be obtained, a more particular description of the disclosure briefly described above will be rendered by reference to specific embodiments thereof which are illustrated in the appended drawings. Understanding that these drawings depict only typical embodiments of the disclosure and are not therefore to be considered to be limiting of its scope, the disclosure will be described and explained with additional specificity and detail through the use of the accompanying drawings in which:

FIG. 1 is an oblique perspective view of an embodiment in accordance with the present disclosure.

FIG. 2 is a close oblique perspective view of a buckle end of an embodiment in accordance with the present disclosure.

FIG. 3 is a bottom perspective view of a buckle end of an embodiment in accordance with the present disclosure.

FIG. 4 is a bottom perspective view of a belt end of an embodiment in accordance with the present disclosure.

FIG. 5 is a close side perspective view of a buckle end of an embodiment in accordance with the present disclosure.

FIG. 6 is a top perspective view of an embodiment in accordance with the present disclosure.

FIG. 7 is a close oblique perspective view of a belt end of an embodiment in accordance with the present disclosure.

FIG. 8 is a top perspective view of a wearer of an embodiment in accordance with the present disclosure in accordance with an embodiment of the present disclosure.

FIG. 9A is a front perspective view of a wearer of an embodiment in accordance with the present disclosure.

FIG. 9B is a front perspective view of a wearer of an embodiment in accordance with the present disclosure.

FIG. 9C is a front perspective view of a wearer of an embodiment in accordance with the present disclosure.

FIG. 9D is a front perspective view of a wearer of an embodiment in accordance with the present disclosure.

FIG. 9E is a front perspective view of a wearer of an embodiment in accordance with the present disclosure.

FIG. 9F is a front perspective view of a wearer of an embodiment in accordance with the present disclosure.

### DETAILED DESCRIPTION

The present disclosure relates to safety equipment. In particular, embodiments of the present disclosure can include a belt portion extending in a longitudinal direction and having a central longitudinal axis. The belt portion can have a cut out portion that also extends in a longitudinal direction, and the cut out portion can be centered on the belt portion along the central longitudinal axis. One or more LED light sources can be positioned inside the cut out portion of the belt portion.

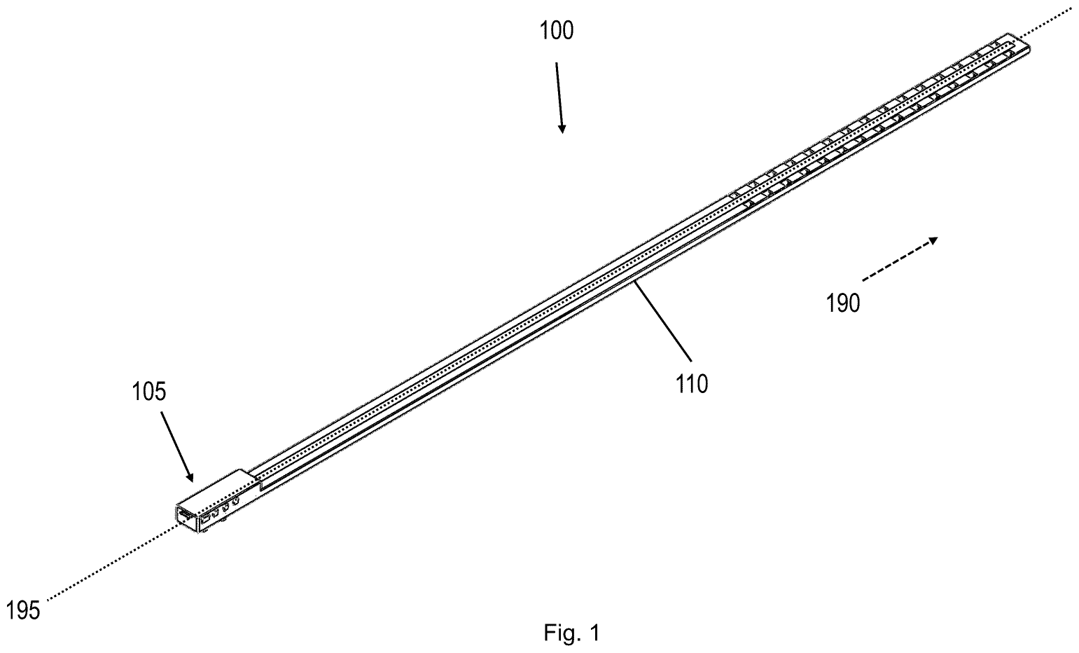

FIG. 1 is an oblique perspective view of an embodiment in accordance with the present disclosure. As shown in FIG. 1, embodiments of the present disclosure can include a wearable safety lighting system 100. The wearable safety lighting system 100 can include a belt portion 110 extending in a longitudinal direction 190 having a central longitudinal axis 195. The wearable safety lighting system 100 can also include a buckle portion 105 on a first end of the wearable safety lighting system 100.

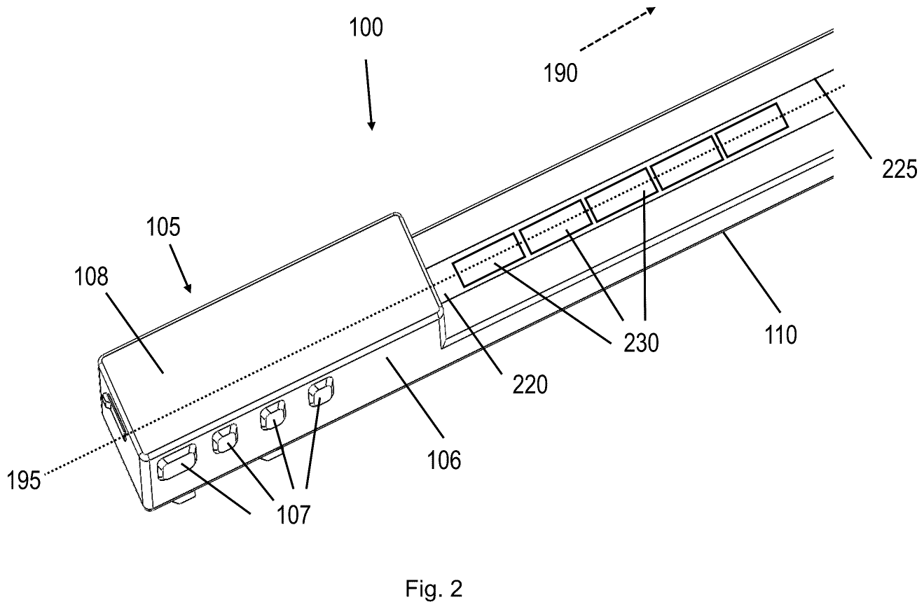

FIG. 2 is a close oblique perspective view of a buckle end of an embodiment in accordance with the present disclosure. According to FIG. 2, the buckle portion 105 can include a housing 106 and one or more buttons 107. The buckle portion 105 can include a top surface 108 that can comprise a heat absorbing material such as oxidized aluminum. The oxidized aluminum can be any color and can be at least partially transparent. At least this can beneficially enable the top surface 108 to absorb heat generated by a computer system disposed inside the buckle portion 105. In some embodiments, the heat absorbing material acts as a heat sink for the heat generated by the computer system and thus can include any suitable material for that purpose.

The buckle portion 105 may comprise a material that is different than the material of the belt portion 110, or it may comprise the same material as the belt portion 110. According to some embodiments, the buckle portion 105 can be attached to the belt portion 110 via chemical fusion or a permanent connector.

The belt portion 110 may be made out of any suitable material. For example, the belt portion 110 may be made primarily out of silicone. According to some embodiments, the belt portion 110 may be made primarily out of thermoplastic elastomers (TPE). Additionally or alternatively, a broad range of similar materials may be incorporated into the belt portion to achieve comparable functional and mechanical properties. These may include thermoplastic polyurethanes (TPU), styrenic block copolymers (SBCs), ethylene-vinyl acetate (EVA), polyolefin elastomers (POEs), thermoplastic vulcanizates (TPVs), liquid silicone rubber (LSR), fluoroelastomers (FKM), and various grades of synthetic rubber such as nitrile butadiene rubber (NBR) and ethylene propylene diene monomer (EPDM). Additionally or alternatively, other soft-touch or elastomeric polymers like plastisol (PVC-based), polyether block amide (PEBA), and low-durometer polyurethanes may be suitable alternatives depending on application-specific requirements such as flexibility, durability, chemical resistance, biocompatibility, or temperature tolerance. These materials can be formulated, molded, or co-molded to provide tactile, sealing, or structural characteristics analogous to those offered by TPE and silicone. Similar materials and/or combinations thereof may be incorporated into the wearable safety lighting system 100.

According to some embodiments, the buckle portion 105 can include a computer system and batteries, both of which can be suspended inside the buckle portion 105. This may beneficially reduce any movement of the computer system and/or the batteries once the buckle portion 105 is assembled.

As shown in FIG. 2, the belt portion 110 can include a cut out portion 220 that also extends in the longitudinal direction 190. The cut out portion 220 can be centered on the belt portion 110 along the central longitudinal axis 195. One or more LED light sources 230 can be positioned inside the cut out portion 220 of the belt portion 110.

According to an embodiment, the one or more LED light sources 230 can be connected in an LED lighting strip and can have a height that is not greater than a height of an inside edge 225 of the cut out portion 220 of the belt portion 110. The LED lighting strip can have a height that is equal to the height of the inside edge 125 of the cut out portion 220. The cut out portion 220 can beneficially improve the wearer experience of embodiments of the present disclosure by providing a cavity in which the one or more LED light sources 230 may be positioned such that the one or more LED light sources do not protrude from the belt portion 110, providing a smooth overall feel to the wearable safety lighting system 100.

According to an embodiment, the cut out portion 220 can also beneficially improve the wearer experience by reducing, minimizing, or completely eliminating the ability of the wearer to directly see light emitted by the one or more LED light sources 230. This can advantageously increase visibility of the wearer's surroundings while not exposing the wearer to light generated by the one or more LED light sources 230 directly and thus protecting eyes of the wearer from irritation and damage.

The LED lighting strip can have a longitudinal length that is shorter than a longitudinal length of the cut out portion 220 of the belt portion 110. According to an embodiment, only a first end of the LED lighting strip 135 can be attached to the cut out portion 220, such that the LED lighting strip is able to longitudinally move within the cut out portion 220 of the belt portion 110 when the belt portion 110 is flexed or wrapped around something. This may beneficially enable the LED lighting strip 135 to move within the cut out portion 220 longitudinally such that when the belt portion 110 flexes, the LED lighting strip 135 moves within the cut out portion 220 and does not break, improving the overall durability of the wearable safety lighting system 100.

The one or more LED light sources beneficially can improve the ability of the wearer to see in an area around them. According to some embodiments, the one or more LED light sources can enable the wearer to have a greater visibility of their surroundings while also improving the visibility of the wearer to the wearer's surroundings. For example, the one or more LED light sources can be bright enough to cast a visible cone of light in a radius around the wearer. The radius can be of sufficient length such that the wearer can see in at least a 5 foot radius around the wearer.

One advantageous embodiment of the present disclosure includes one or more LED light sources that illuminate an area in 360 degrees around a wearer of the wearable safety lighting system 100. This area may have an illumination radius. The illumination radius may be 5 feet, 10 feet, 15 feet, 20 feet, and/or 25 feet. It may be in any or all of the ranges including 5-10 feet, 10-15 feet, 15-20 feet, and/or 20-25 feet. The illumination radius may be in the range including 5-25 feet, or may even exceed 25 feet. This may be especially beneficial, as the illumination radius being large can enable a wearer to see in low light conditions while enabling safety advantages of being seen by others.

The illumination radius may be visible in low-light conditions, such as in the absence of light, during the nighttime, and/or during the dusk and dawn hours. In some embodiments, the illumination radius can be large due to the one or more LED light sources. The one or more LED light sources can be bright enough to create a large illumination radius, such as the illumination radius discussed. Additionally, there may be a diffusor and/or one or more reflective surfaces on the cut out portion 220 of the wearable safety lighting system. The diffusor and/or one or more reflective surfaces can enable the one or more LED light sources to create the illumination radius.

According to some embodiments, the wearable safety system can also include a computer system disposed within the housing 106 of the belt portion 110 and in communication with the one or more LED light sources 230. The computer system can include one or more processors and one or more computer-readable hardware storage devices that store instructions that can be executable by the one or more processors to cause the computer system to selectively display, on the one or more LED light sources, a lighting regime that can include at least one color.

The lighting regime can also include displaying exactly one color. The displayed color can be any color, such as red, blue, green, and/or any possible combination thereof.

The lighting regime can also include a lighting effect. For example, it may include a strobe effect, a fading effect, a flashing effect, an intermittent effect, a cycling effect, a gradient effect, a brightness effect, a dimming effect, and/or any other lighting effect. The lighting regime may also include illuminating only a portion of the one or more LED light sources. The lighting regime may also include illuminating a single LED of the one or more LED light sources. The lighting regime may also include illuminating all of the LEDs in the one or more LED light sources.

The lighting regime may include more than one color. The more than one color can be a first color, such as red, blue, green, and/or any possible combination thereof and a second color, such as red, blue, green, and/or any possible combination thereof. There may be any number of colors such as red, blue, green, and/or any possible combination thereof in addition to the first and second colors.

The lighting regime may include a combination of at least one color and at least one lighting effect. For example, the lighting regime may include a strobing effect and the color green. The lighting regime may also include a gradient effect from a first color to a second color.

In some embodiments, the wearable lighting system can include one or more sensors connected to the belt portion of the wearable lighting system. The one or more sensors may receive data about an environment of a wearer of the wearable safety lighting system. For example, the sensor may be a microphone, thermometer, accelerometer, photodiode, speedometer, and/or any other sensor. The sensors may be communicably connected to the computer system such that the computer system receives and/or retrieves data from the sensors.

According to an advantageous embodiment, the wearable lighting system can include a computer system that can include one or more computer-readable hardware storage devices that store instructions that can be executable by the one or more processors to cause the computer system to retrieve data from the one or more sensors, determine, based on the data, a corresponding lighting regime, and display, on the one or more LED light sources, the corresponding lighting regime.

For example, the sensor can be an accelerometer connected to the belt portion of the wearable safety system. The accelerometer can send data indicating that the belt portion of the wearable safety system was tapped. The computer system can then be caused to determine that the corresponding lighting regime is to flash a portion of the one or more LED light sources that is proportionate to a remaining battery life of the wearable safety lighting system. The lighting regime at least in this way can convey information to the wearer of the wearable safety lighting system.

In one embodiment, the corresponding lighting regime can be used to display one or more colors on the one or more LED light sources that indicate temperature data. For example, one of the colors may be a red color to indicate a hot temperature, and one color may be a blue color to indicate a cold temperature. There can be a gradient effect included in the corresponding lighting regime to show more data about the temperature.

In one embodiment, the corresponding lighting regime can display information about the computer system. For example, in response to retrieving accelerometer data indicating a tapping of the belt portion, the corresponding lighting regime can indicate which lighting regime is currently being displayed.

In general, the corresponding lighting regime can be used to convey information to a wearer of the wearable safety lighting system. The information can be from one or more sensors connected to the wearable safety lighting system, or the information can be about the wearable safety lighting system itself.

As shown in FIG. 2, the housing 106 can include one or more buttons 107. The one or more buttons 107 can interact with and/or control the computer system. For example, a button in the one or more buttons 107 can control an operating mode of the wearable safety lighting system. A button in the one or more buttons 107 may also allow a wearer to input commands to the computer system.

According to some embodiments, the one or more buttons can also be used to control the one or more LED light sources 230 directly. For example, responsive to one of the buttons being pressed, the one or more LED light sources 230 may turn on or turn off.

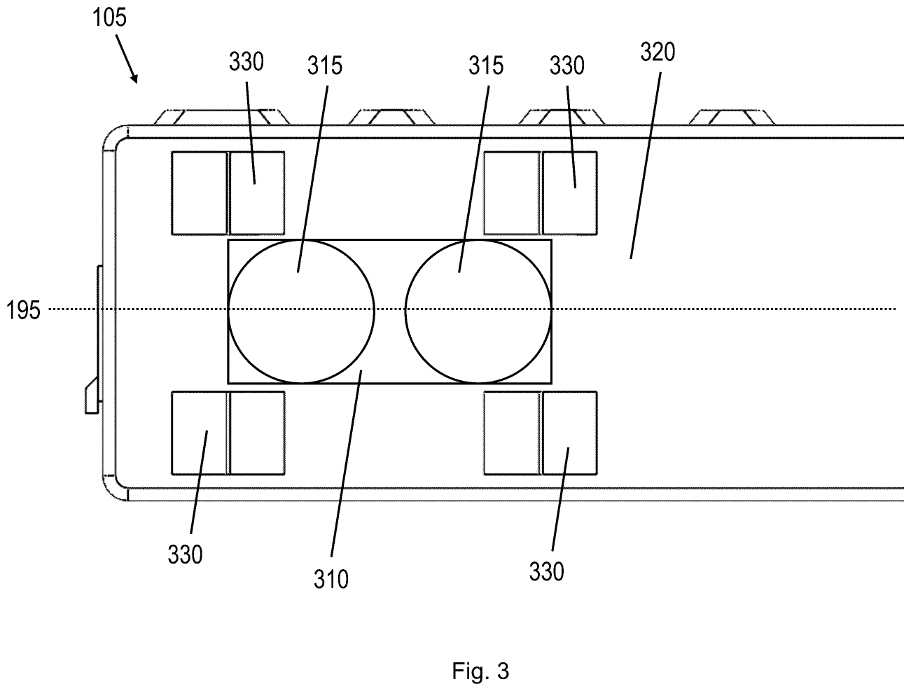

FIG. 3 is a bottom perspective view of a buckle end of an embodiment in accordance with the present disclosure. According to FIG. 3, the buckle portion 105 can include one or more hooks 330. The one or more hooks 330 may be configured to connect to one or more holes disposed on the belt portion 110 of the wearable safety lighting system. The hooks may have a shape that corresponds to a receiving shape of the one or more holes. According to some embodiments, the one or more hooks 330 position and secure the buckle portion 105 to the belt portion 110. In at least such a way, a secure, comfortable, and quick connection can be made and secured between the buckle portion 105 and the belt portion 110.

According to FIG. 3, the buckle portion 105 can include a bottom surface 320 and a magnetic locking mechanism 310. The magnetic locking mechanism 310 can include one or more magnets 315. While a particular number of magnets is shown in FIG. 3, any number of magnets can be included in the one or more magnets 315. According to some embodiments, the magnetic locking mechanism 310 can be on the bottom surface 320 of the buckle portion 105, or the magnetic locking mechanism 310 can be suspended within the buckle portion 105 and not be visible on the bottom surface 320 of the buckle portion 105.

According to some embodiments, the bottom surface 320 may comprise a different material than the belt portion described above regarding some embodiments. For example, the bottom surface 320 may be made primarily out of a hard plastic acrylonitrile butadiene styrene (ABS) or any similar thermoplastic polymer offering comparable mechanical, thermal, or aesthetic properties. Suitable alternative materials include high-impact polystyrene (HIPS), polycarbonate-ABS blends (PC-ABS), polystyrene-acrylonitrile (SAN), polypropylene (PP), polycarbonate (PC), and other engineering-grade thermoplastics or copolymers with similar moldability, impact resistance, rigidity, and surface finish characteristics. Such materials may be selected based on application-specific criteria such as structural strength, chemical resistance, heat tolerance, or cost-efficiency, and may be used alone or in combination, including as alloys, blends, or multilayer structures.

As shown in FIG. 3, each magnet in the one or more magnets 315 can be aligned along the central longitudinal axis 195 of the belt portion 110. According to some embodiments, there can be exactly two magnets that are aligned along the central longitudinal axis 195. According to some embodiments, there can be exactly one magnet aligned along the central longitudinal axis 195.

According to some embodiments, the one or more magnets 315 can also be offset from the central longitudinal axis 195. There can be pairs of magnets aligned on either side of the central longitudinal axis 195. There can be some magnets that are aligned with the central longitudinal axis 195 and some magnets that are not aligned with the central longitudinal axis 195.

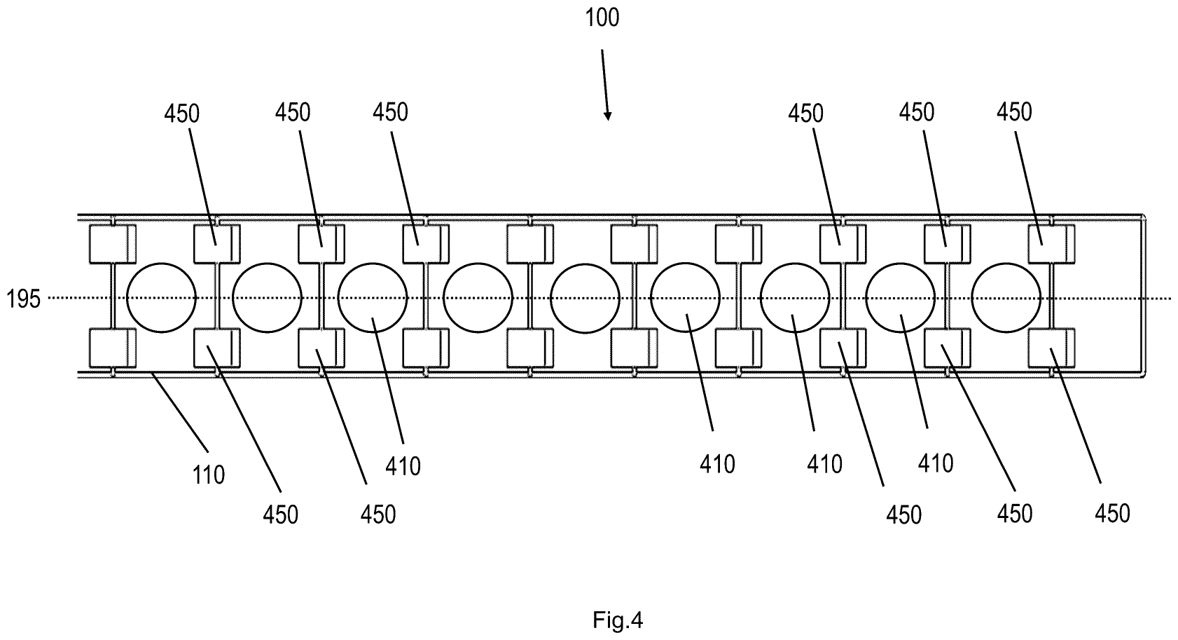

The one or more magnets 315 can be configured to magnetically connect to one or more magnets disposed on the belt portion 110 of the wearable safety lighting system 100. In at least such a way, the one or more magnets 315 can position the buckle portion 105 on the belt portion 110 and thus put the wearable safety lighting system 100 into a closed configuration. For example, a wearer of the wearable safety lighting system 100 may loop the wearable safety lighting system 100 around the wearer's body and may place the buckle portion 105 over the belt portion 110. The one or more magnets of each portion may engage one another and magnetically affix the buckle portion 105 to the belt portion 110. The hooks may also engage with one or more holes disposed on the belt portion (see, for example, FIG. 4). In at least such a way, the one or more magnets 315 and the one or more hooks 330 can be configured to work together and support one another to position and secure the buckle portion 105 to the belt portion 110. This can enable a quicker and more convenient connection to be established between the belt portion 110 and the buckle portion 105. A discussion of the belt portion 110 follows in reference to FIG. 4.

FIG. 4 is a bottom perspective view of a belt end of an embodiment in accordance with the present disclosure. As shown in FIG. 4, the belt portion 110 of the wearable safety lighting system 100 can include one or more magnets 410. While the one or more magnets 410 are shown in FIG. 4, the one or more magnets 410 can be disposed inside the belt portion 110 and thus would not be visible from the bottom perspective view as shown in FIG. 4. According to some embodiments, each magnet in the one or more magnets 410 can define a belt length when engaged with a magnetic locking mechanism, for example the magnetic locking mechanism 310 from FIG. 3. For example, the one or more magnets 315 of the magnetic locking mechanism 310 can engage a first magnet of the one or more magnets 410 and place the wearable safety lighting system 100 into a closed configuration, and a resulting circumference of the closed configuration can be a first circumference.

The one or more magnets 315 of the magnetic locking mechanism 310 can engage a second magnet of the one or more magnets 410, and the resulting circumference of the belt portion 110 can be a second circumference which his bigger or smaller than the first circumference. In such a way, the magnetic locking mechanism 310 can beneficially enable a wearer to customize the circumference of the belt portion 110 to fit a waist of the wearer. Thus, embodiments of the present disclosure can enable a customizable, secure, and convenient fit for a wearer.

According to some embodiments, there can be exactly one magnet 410 that is disposed at a particular position on the belt portion 110 to provide a fixed circumference when the wearable safety lighting system 100 is placed into the closed configuration.

According to FIG. 4, the one or more magnets 410 can be aligned along the central longitudinal axis 195 of the belt portion 110. There may be one or more cavities inside the belt portion 110 disposed along the central longitudinal axis 195 wherein each magnet is positioned. Each cavity may have a depth that corresponds to a depth of a magnet 410. In at least such a way, the cavity may enable each magnet in the one or more magnets to be positioned in the belt portion without any adhesive or connecting material.

According to an embodiment, at least one magnet in the one or more magnets may be positioned in the belt portion with adhesive means. For example, the at least one magnet in the one or more magnets may be positioned in the belt by means of a glue.

As shown in FIG. 4, the belt portion 110 can include one or more holes 450 disposed along the longitudinal direction 190 and extending transverse thereto through an entire width of the belt portion 110. The one or more holes 450 can be configured to receiving hooks of the buckle portion, for example the one or more hooks 330 of the buckle portion 105. The one or more holes 450 can be in any configuration or placement on the belt portion 110 such that the one or more holes 150 is configured with the magnetic locking mechanism 310 to beneficially enable a wearer to customize a fit of embodiments of the present disclosure and to provide a secure, convenient, and quick positioning and locking of the buckle portion 105 to the belt portion 110.

As shown in FIG. 4, the one or more holes 450 may be configured into two rows of holes that line either side of the central longitudinal axis. Additionally or alternatively, each hole in the one or more holes 450 may be paired with a different hole in the one or more holes that is disposed on the opposite side of the central longitudinal axis to receive a pair of hooks. Each hole in the one or more holes 450 may have a shape that is a receiving shape that corresponds to the one or more hooks 330 which can enable a tighter hold.

The wearable safety lighting system can also include one or more buttons connected to the belt portion and communicable connected with the computer system of the wearable safety lighting system. The one or more buttons may control features of the computer system. For example, one of the one or more buttons may display on the one or more LED light sources a corresponding lighting regime to that button when that button is pressed.

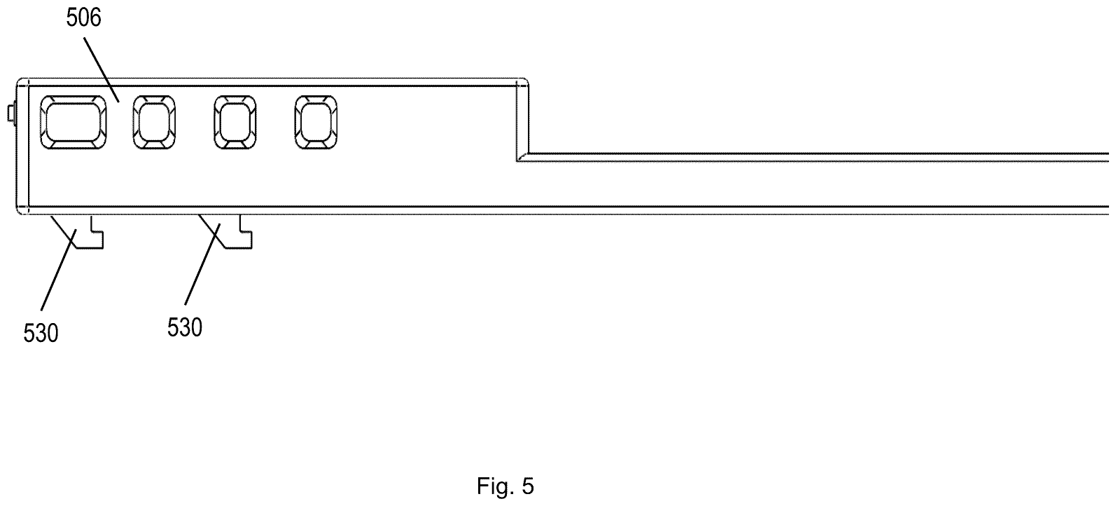

FIG. 5 is a close side perspective view of a buckle end of an embodiment in accordance with the present disclosure. As shown in FIG. 5, one or more hooks 530 may extend from a housing 506. The one or more hooks 530 may be located on the bottom face of the housing 506. The one or more hooks 530 may allow the housing to be firmly affixed to a belt portion of the embodiment. Additionally, while two hooks are shown in FIG. 5, there may be any number of hooks, including one hook, two hooks, three hooks, four hooks, five hooks, and/or six hooks. The one or more hooks 530 may be configured to match and connect with holes that are on the belt portion as discussed previously.

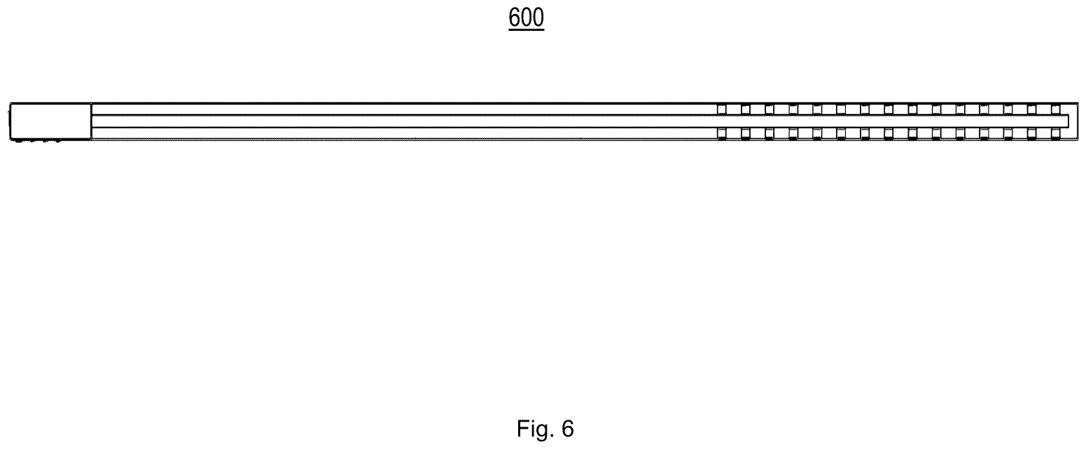

FIG. 6 is a top perspective view of an embodiment in accordance with the present disclosure. FIG. 6 shows an embodiment of a wearable safety lighting system 600 that is in an un-bended configuration. As discussed above, the wearable safety lighting system 600 may be made of a flexible material such that a wearer or user of the wearable safety lighting system 600 may bend the wearable safety lighting system 600 around a body of the wearer or user. As discussed previously, the wearable safety lighting system 600 may be affixed to itself using one or more hooks and in such a way may retain its bent shape. However, when the one or more hooks are disengaged, the material of the wearable safety lighting system 600 may cause the wearable safety lighting system 600 to return to its un-bended configuration as shown in FIG. 6, or it may stay in its bent configuration, depending on the flexibility, rigidity, and elasticity of the material.

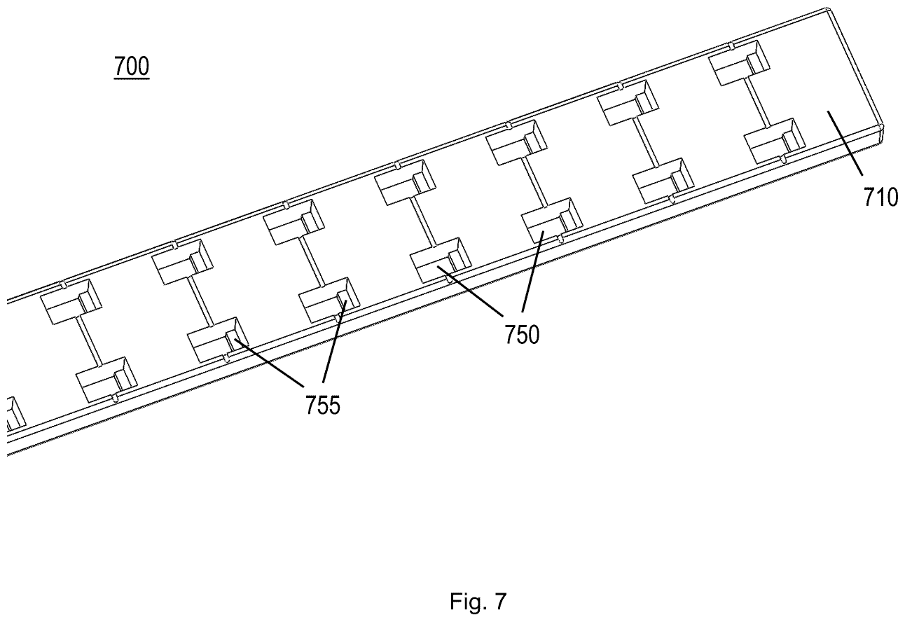

FIG. 7 is a close oblique perspective view of a belt end of an embodiment in accordance with the present disclosure. Similar to FIG. 4, FIG. 7 shows that a wearable safety lighting system 700 may include a belt portion 710 that may include one or more holes 750. The one or more holes 750 may be similar to the one or more holes 450 of FIG. 4, and a similar description as discussed above may apply to the one or more holes 750. FIG. 7 also shows that the one or more holes 750 may be interrupted by a locking feature 755 that juts into the one or more holes 750. The locking feature 755 may change the shape of the one or more holes 750 such that the shape of the one or more holes 750 is adapted to engage with one or more hooks as described above in order to lock the one or more hooks into place.

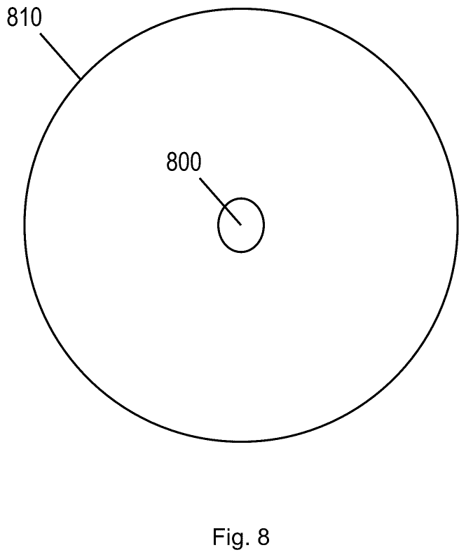

FIG. 8 is a top perspective view of a wearer of an embodiment of the present disclosure in accordance with an embodiment of the present disclosure. The wearer 800 may be, for example, a construction worker, a highway safety worker, and/or a security guard. The wearer 800 may be wearing a wearable safety lighting system similar to those embodiments described above. In particular, the wearable safety lighting system may cast light in an illumination radius that defines a circle 810.

The light within the illumination radius provided by the wearable safety lighting system may be sufficient to conduct the work that the wearer of the wearable safety lighting system may need to do, while simultaneously improving the visibility of the wearer. This beneficially may reduce the amount of equipment necessary for the worker to wear while on a job site or while conducting the worker's job.

As an illustrative example, a highway safety worker may require light to read signs, to arrange equipment, and to set up the work area. Often this work is conducted in low light conditions such as during dusk or nighttime. Such low light conditions can increase the danger posed to the worker by cars as the cars drive by. A wearable safety lighting system according to embodiments described herein may alleviate this danger by casting light around the worker while simultaneously providing the necessary light for the worker to complete the worker's task.

While the illumination circle 810 is shown in FIG. 8, the inventors of the present disclosure have found that this circle may be the circle containing sufficient light for the worker to accomplish their task. The light emitted by the wearable safety lighting system according to embodiments described herein may go beyond the radius of the illumination circle 810 and be visible to anyone at a range exceeding the illumination circle's radius.

For example, the safety highway worker may wear a wearable safety lighting system according to some embodiments described herein and may cast enough light that the worker may not require additional light sources within a 15 foot radius of the worker. However, the wearable safety lighting system may emit sufficient light such that the worker is visible at a distance exceeding 15 feet from the worker, for example a distance exceeding a hundred feet from the worker. In at least this way, embodiments of the present disclosure may allow a worker to see and to be seen.

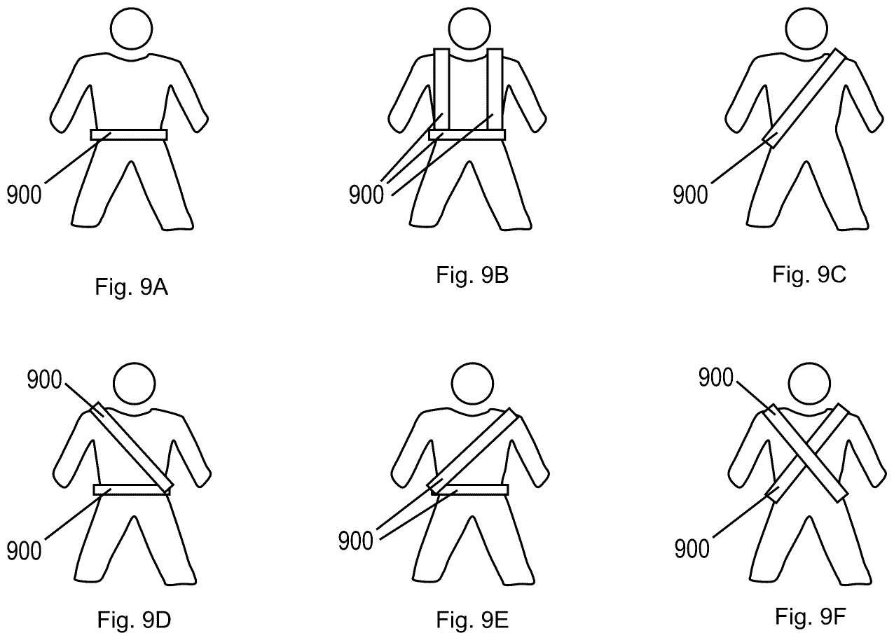

FIG. 9A is a front perspective view of a wearer of an embodiment in accordance with the present disclosure.

FIG. 9B is a front perspective view of a wearer of an embodiment in accordance with the present disclosure.

FIG. 9C is a front perspective view of a wearer of an embodiment in accordance with the present disclosure.

FIG. 9D is a front perspective view of a wearer of an embodiment in accordance with the present disclosure.

FIG. 9E is a front perspective view of a wearer of an embodiment in accordance with the present disclosure.

FIG. 9F is a front perspective view of a wearer of an embodiment in accordance with the present disclosure.

As shown in FIGS. 9A-9F, embodiments of the present disclosure may include one or more wearable safety lighting systems 900 arranged on a body of a wearer in a number of configurations. Where the configuration has more than one wearable safety lighting system 900, each wearable safety lighting system 900 may be in communication with the other wearable safety lighting systems 900 in the configuration.

Additionally, according to some embodiments, a method for manufacturing a wearable safety lighting system can include injection molding. The method for manufacturing can also include chemical and mechanical fusion, compression molding, casting, or other attaching steps. The method can include creating different feature of the embodiments and later assembling them to create the wearable safety lighting system.

### Additional or Alternative Embodiments

Embodiments of the present disclosure can be described in additional or alternative embodiments as follows, which language does not limit the disclosure to any particular embodiment. In an additional or alternative embodiment, a wearable safety lighting system includes: a belt portion extending in a longitudinal direction and having a central longitudinal axis, the belt portion having a cut out portion that also extends in a longitudinal direction, the cut out portion being centered on the belt portion along the central longitudinal axis; and one or more LED light sources positioned inside the cut out portion of the belt portion.

In an additional or alternative embodiment, the belt portion further can include a magnetic locking mechanism on a first end of the belt portion that can comprise: a magnetic engaging mechanism on a first end of the belt portion; and one or more magnets, each magnet in the one or more magnets being aligned along the central longitudinal axis of the belt portion, each magnet in the one or more magnets being placed such that each magnet defines a belt length when engaged with the magnetic engaging mechanism

In an additional or alternative embodiment, the one or more LED light sources can be connected in an LED lighting strip, the LED lighting strip having a longitudinal length and a height that is not greater than a height of an inside edge of the cut out portion of the belt portion.

In an additional or alternative embodiment, the longitudinal length of the LED lighting strip can be shorter than a longer longitudinal length of the cut out portion of the belt portion.

In an additional or alternative embodiment, only a first end of the LED lighting strip can be attached to the cut out portion such that the LED lighting strip is able to longitudinally move within the cut out portion of the belt portion.

In an additional or alternative embodiment, the belt portion comprises silicone.

In an additional or alternative embodiment, the one or more LED light sources emit light in a 360 degree radius around a wearer of the wearable safety lighting system.

In an additional or alternative embodiment, a wearable safety lighting system can include: a belt portion extending in a longitudinal direction and having a central longitudinal axis, the belt portion having a cut out portion that also extends in a longitudinal direction, the cut out portion being centered on the belt portion along the central longitudinal axis; one or more LED light sources positioned inside the cut out portion of the belt portion; and a computer system attached to the belt portion and in communication with the one or more LED light sources, comprising: one or more processors; and one or more computer-readable hardware storage devices that store instructions that are executable by the one or more processors to cause the computer system to selectively display, on the one or more LED light sources, a lighting regime comprising at least one color.

In an additional or alternative embodiment, the lighting regime can comprise lighting only a portion of the one or more LED light sources.

In an additional or alternative embodiment, the lighting regime can include alternating two or more colors sequentially.

In an additional or alternative embodiment, the lighting regime can include a color selected from a group consisting of red, yellow, green, blue, white, and black.

In an additional or alternative embodiment, the lighting regime further can include a brightness level in the range from 0% to 100%.

In an additional or alternative embodiment, the computer system can selectively display, on the one or more LED light sources, the lighting regime based on a wearer input.

In an additional or alternative embodiment, a wearable safety lighting system can include: a belt portion extending in a longitudinal direction and having a central longitudinal axis, the belt portion having a cut out portion that also extends in a longitudinal direction, the cut out portion being centered on the belt portion along the central longitudinal axis; and one or more LED light sources, the one or more LED light sources being positioned inside the cut out portion of the belt portion; one or more sensors connected to the belt portion; a computer system, the computer system being attached to the belt portion and in communication with the one or more LED light sources, comprising: one or more processors; and one or more computer-readable hardware storage devices that store instructions that are executable by the one or more processors to cause the computer system to: retrieve data from the one or more sensors; determine, based on the data, a corresponding lighting regime; and display, on the one or more LED light sources, the corresponding lighting regime.

In an additional or alternative embodiment, the one or more sensors can be selected from a group consisting of microphone, thermometer, accelerometer, and photodiode.

In an additional or alternative embodiment, the data can be battery percentage data, and the corresponding lighting regime can include lighting up a percentage of the one or more LED light sources that corresponds to the battery percentage data.

In an additional or alternative embodiment, the data can be temperature data, and the corresponding lighting regime can include lighting up each LED in the one or more LED light sources a color that corresponds to the temperature data.

In an additional or alternative embodiment, the data can light data, and the corresponding lighting regime can include a brightness that corresponds to the light data.

In an additional or alternative embodiment, the data can be movement data that corresponds to a motion of the wearable safety lighting system being tapped by a wearer, and the corresponding lighting regime can include activating the one or more LED light sources from a deactivated state.

In an additional or alternative embodiment, the data can be movement data that corresponds to a motion of the wearable safety lighting system being tapped by a wearer, and the corresponding lighting regime can include deactivating the one or more LED light sources from an activated state.

The foregoing embodiments provide a wearable safety lighting system, and methods of using the same, that can enable a wearer to both see their surrounding environment while improving visibility of the wearer. This beneficially allows the wearer a heightened security, a greater amount of activities in low-light conditions, and a greater understanding of otherwise unknown factors in the wearer's environment.

The present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes that come within the meaning and range of equivalency of the claims are to be embraced within their scope.

The features, elements, and embodiments described herein may be combined in various ways and are not limited to the specific combinations explicitly described. Any feature of any embodiment may be combined with any other feature of any other embodiment unless explicitly stated otherwise. All such combinations are intended to be within the scope of the present disclosure and the appended claims.

What is claimed is:

1. A wearable safety lighting system, comprising:
a belt portion extending in a longitudinal direction and having a central longitudinal axis, the belt portion having a cut out portion that also extends in a longitudinal direction, the cut out portion being centered on the belt portion along the central longitudinal axis; and
one or more LED light sources positioned inside the cut out portion of the belt portion.

2. The wearable safety lighting system of claim 1, wherein the belt portion further comprises a magnetic locking mechanism on a first end of the belt portion comprising:
a magnetic engaging mechanism on a first end of the belt portion; and
one or more magnets, each magnet in the one or more magnets being aligned along the central longitudinal axis of the belt portion, each magnet in the one or more magnets being placed such that each magnet defines a belt length when engaged with the magnetic engaging mechanism.

3. The wearable safety lighting system of claim 1, wherein the one or more LED light sources are connected in an LED lighting strip, the LED lighting strip having a longitudinal length and a height that is not greater than a height of an inside edge of the cut out portion of the belt portion.

4. The wearable safety lighting system of claim 3, wherein the longitudinal length of the LED lighting strip is shorter than a longer longitudinal length of the cut out portion of the belt portion.

5. The wearable safety lighting system of claim 3, wherein only a first end of the LED lighting strip is attached to the cut out portion such that the LED lighting strip is able to longitudinally move within the cut out portion of the belt portion.

6. The wearable safety lighting system of claim 1, wherein the belt portion comprises silicone.

7. The wearable safety lighting system of claim 1, wherein the one or more LED light sources emit light in a 360 degree radius around a wearer of the wearable safety lighting system.

8. A wearable safety lighting system comprising:
a belt portion extending in a longitudinal direction and having a central longitudinal axis, the belt portion having a cut out portion that also extends in a longitudinal direction, the cut out portion being centered on the belt portion along the central longitudinal axis;
one or more LED light sources positioned inside the cut out portion of the belt portion; and
a computer system attached to the belt portion and in communication with the one or more LED light sources, comprising:
one or more processors; and
one or more computer-readable hardware storage devices that store instructions that are executable by the one or more processors to cause the computer system to selectively display, on the one or more LED light sources, a lighting regime comprising at least one color.

9. The wearable safety lighting system of claim 8, wherein the lighting regime comprises lighting only a portion of the one or more LED light sources.

10. The wearable safety lighting system of claim 8, wherein the lighting regime comprises alternating two or more colors sequentially.

11. The wearable safety lighting system of claim 8, wherein the lighting regime comprises a color selected from a group consisting of red, yellow, green, blue, white, and black.

12. The wearable safety lighting system of claim 8, wherein the lighting regime comprises a brightness level in a range from 0% to 100%.

13. The wearable safety lighting system of claim 8, wherein the computer system selectively displays, on the one or more LED light sources, the lighting regime based on a wearer input.

14. A wearable safety lighting system comprising:
a belt portion extending in a longitudinal direction and having a central longitudinal axis, the belt portion having a cut out portion that also extends in a longitudinal direction, the cut out portion being centered on the belt portion along the central longitudinal axis; and
one or more LED light sources, the one or more LED light sources being positioned inside the cut out portion of the belt portion;
one or more sensors connected to the belt portion;
a computer system, the computer system being attached to the belt portion and in communication with the one or more LED light sources, comprising:
one or more processors; and
one or more computer-readable hardware storage devices that store instructions that are executable by the one or more processors to cause the computer system to:
retrieve data from the one or more sensors;
determine, based on the data, a corresponding lighting regime; and
display, on the one or more LED light sources, the corresponding lighting regime.

15. The wearable safety lighting system of claim 14, wherein the one or more sensors are selected from a group consisting of microphone, thermometer, accelerometer, and photodiode.

16. The wearable safety lighting system of claim 14, wherein the data is battery percentage data, and the corresponding lighting regime comprises lighting up a percentage of the one or more LED light sources that corresponds to the battery percentage data.

17. The wearable safety lighting system of claim 14, wherein the data is temperature data, and the corresponding lighting regime comprises lighting up each LED in the one or more LED light sources a color that corresponds to the temperature data.

18. The wearable safety lighting system of claim 14, wherein the data is light data, and the corresponding lighting regime comprises a brightness that corresponds to the light data.

19. The wearable safety lighting system of claim 14, wherein the data is movement data that corresponds to a motion of the wearable safety lighting system being tapped by a wearer, and the corresponding lighting regime comprises activating the one or more LED light sources from a deactivated state.

20. The wearable safety lighting system of claim 14, wherein the data is movement data that corresponds to a motion of the wearable safety lighting system being tapped by a wearer, and the corresponding lighting regime comprises deactivating the one or more LED light sources from an activated state.
